(19) United States
(12) Patent Application Publication
(10) Pub. No.: US 2024/0200211 A1
(43) Pub. Date: Jun. 20, 2024

(54) ELECTRODE CATALYST COMPOSITE CONTAINING 2D TRANSITION METAL CHALCOGENIDE MATERIAL FOR WATER ELECTROLYSIS AND MANUFACTURING METHOD THEREOF

(71) Applicant: RESEARCH & BUSINESS FOUNDATION SUNGKYUNKWAN UNIVERSITY, Suwon-si (KR)

(72) Inventors: Jung Kyu KIM, Suwon-si (KR); Min Cheol KIM, Suwon-si (KR); Won SO, Suwon-si (KR); Jae Kyum KIM, Suwon-si (KR); Ho Seok PARK, Suwon-si (KR)

(73) Assignee: RESEARCH & BUSINESS FOUNDATION SUNGKYUNKWAN UNIVERSITY, Suwon-si (KR)

(21) Appl. No.: 18/539,661

(22) Filed: Dec. 14, 2023

(30) Foreign Application Priority Data
Dec. 15, 2022 (KR) 10-2022-0176305

(51) Int. Cl. C25B 11/065; C25B 1/04; C25B 11/091

(52) U.S. Cl. CPC C25B 11/065; C25B 1/04; C25B 11/091

(57) ABSTRACT

An embodiment of the present invention provides an electrocatalyst composite including a 2D transition metal chalcogenide material for water electrolysis and a method for manufacturing the same. According to one embodiment of the present invention, the electrocatalyst composite for water electrolysis is manufactured by hetero-junctioning 2D nickel cobalt sulfide (NiCo₂S₄) and 2D rhenium sulfide (ReS₂) to allow for high activity and application over a broad pH range during water electrolysis.

### CROSS REFERENCE TO RELATED APPLICATION

The present application claims priority to Korean Patent Application No. 10-2022-0176305, filed Dec. 15, 2022, the entire contents of which are incorporated herein for all purposes by this reference.

### BACKGROUND OF THE INVENTION

### Field of the Invention

This invention relates to an electrocatalyst composite containing 2-dimensional (2D) transition metal chalcogenide material for water electrolysis and manufacturing method thereof. Description of the Related Art

The hydrogen evolution reaction (HER) through electrochemical water splitting is considered an efficient alternative to address the global energy crisis and environmental pollution issues.

However, this reaction typically requires expensive noble metal-based catalysts such as platinum and ruthenium, posing a limitation to their widespread use due to the high cost and scarcity of these catalysts.

Furthermore, conventional noble metal-based catalysts struggle to exhibit hydrogen evolution reaction catalytic activity across a wide pH range, which is essential for various industrial applications with diverse operating environments ranging from acidic corrosion to alkaline microbial electrolysis. 2D transition metal dichalcogenides (TMDCs) are suitable materials for HER metal catalysts due to their thin structure, large specific surface area, and low hydrogen adsorption free energy. However, using TMDC alone presents a disadvantage in universal use for alkaline HER due to its slow kinetic characteristics in the initial water dissociation phase.

In addition, despite research efforts involving approaches such as elemental doping, chemical exfoliation, and the fabrication of structural composites with conductive supports for the design of ReS2-based HER catalysts, the slow O—H bond cleavage dynamics of ReS2 have hindered overcoming the reaction kinetic limitations for alkaline HER.

Therefore, there are still significant challenges remaining in the development of highly active and stable non-noble transition metal-based catalysts that can operate under various pH conditions.

### SUMMARY OF THE INVENTION

It is an object of the present invention to provide an electrocatalyst composite for water electrolysis that is applicable over a wide pH range through hetero-junction of 2D transition metal chalcogenide materials and manufacturing method thereof.

The objects of the present invention are not limited to the aforesaid, and other objects not described herein with can be clearly understood by those skilled in the art from the descriptions below.

In order to accomplish the objects, an electrocatalyst composite for water electrolysis is provided according to an embodiment of the present invention.

An electrocatalyst composite for water electrolysis according to an embodiment of the present invention includes a carbon substrate, a first transition metal chalcogenide layer comprising 2-dimensional first transition metal chalcogenide nanoparticles, positioned on the carbon substrate, and a second transition metal chalcogenide layer comprising 2-dimensional second transition metal chalcogenide nanoparticles, positioned on the first transition metal chalcogenide layer, wherein the first and second transition metal chalcogenide layers are hetero-junctioned.

According to an embodiment, the first and second transition metal chalcogenide layers may be hetero-junctioned to allow electron transfer from the first transition metal chalcogenide layer to the second transition metal chalcogenide layer.

According to an embodiment, the first transition metal chalcogenide layer may include a metal sulfide comprising one or more metals selected from the group consisting of nickel, cobalt, calcium, magnesium, manganese, iron, copper, zinc, lithium, and aluminum, and sulfur.

According to an embodiment, the second transition metal chalcogenide layer may include molybdenum sulfide, tungsten sulfide, molybdenum selenide, tungsten selenide, molybdenum telluride, manganese selenide, hafnium sulfide, iridium sulfide, niobium sulfide, niobium selenide, tantalum sulfide, tantalum selenide, titanium sulfide, titanium selenide, zirconium sulfide, rhenium selenide, or rhenium telluride.

According to an embodiment, the electrocatalyst composite for water electrolysis may be used as electrode catalyst for oxygen evolution reaction (OER) and hydrogen evolution reaction (HER).

According to an embodiment, the electrocatalyst composite for water electrolysis may exhibit catalytic activity in a solution with a pH range of 1 to 14.

According to an embodiment, the carbon substrate may include one or more selected from the group consisting of carbon cloth, carbon fiber paper, carbon foam, and carbon paper.

According to an embodiment, the first transition metal chalcogenide layer may have a thickness of 20 nm to 50 nm.

According to an embodiment, the second transition metal chalcogenide layer may have a thickness of 5 nm to 30 nm.

In order to accomplish the objects, a method for manufacturing the electrocatalyst composite for water electrolysis is provided according to another embodiment of the present invention.

A method of manufacturing the electrocatalyst composite for water electrolysis according to an embodiment of the present invention may include forming a first transition metal layer on a carbon substrate, forming a first transition metal chalcogenide layer by performing a sulfidation reaction on the first transition metal layer, and forming a second transition metal chalcogenide layer by performing hydrothermal synthesis on the first transition metal chalcogenide layer.

According to an embodiment, the first transition metal layer may include a nickel-cobalt layered double hydroxide (NiCo-LDH) nanosheet.

According to an embodiment, the first transition metal chalcogenide layer may include 2D nickel cobalt sulfide (NiCo₂S₄).

According to an embodiment, the second transition metal chalcogenide layer include 2D rhenium disulfide (ReS₂).

### BRIEF DESCRIPTION OF THE DRAWINGS

FIG. 1 is a schematic diagram illustrating a structure of an electrocatalyst composite for water electrolysis according to an embodiment of the present invention;

FIG. 2 is a diagram illustrating an electron transport mechanism of an electrocatalyst composite for water electrolysis according to an embodiment of the present invention;

FIG. 3 is a flowchart illustrating a manufacturing method of an electrocatalyst composite for water electrolysis according to an embodiment of the present invention;

FIG. 4 is a schematic diagram illustrating a manufacturing method of an electrocatalyst composite for water electrolysis according to an embodiment of the present invention;

FIG. 5 is a scanning electron microscopy (SEM) image representing the electrocatalyst composite for water electrolysis according to an embodiment of the present invention;

FIG. 6 is a graph showing HER activity capability of an electrocatalyst composite for water electrolysis according to an embodiment of the present invention;

FIG. 7 is SEM images observing the surface morphology of an electrocatalyst composite for water electrolysis at each step of the synthesis process according to an embodiment of the present invention; Here, (a) of FIG. 7 represents the SEM image of NiCo-LDH, (b) of FIG. 7 represents the SEM image of NiCo2S4, (c) of

FIG. 7 represents the SEM image of NiCo2S4/ReS2, and (d) of FIG. 7 represents the TEM image of NiCo2S4/ReS2.

FIG. 8 is a transmission electron microscopy (TEM) image observing the surface morphology of an electrocatalyst composite for water electrolysis according to an embodiment of the present invention;

FIG. 9 is a high-resolution transmission electron microscopy (HR-TEM) image of an electrocatalyst composite for water electrolysis according to an embodiment of the present invention; Here, FIG. 8 and (f) and (g) of FIG. 9 represent HR-TEM images, and (h) of FIG. 9 represents an energy dispersive X-ray spectroscopy (EDS) elemental mapping image;

FIG. 10 is an image representing the line profile of an electrocatalyst composite for water electrolysis according to an embodiment of the present invention;

FIG. 11 is a graph showing the X-ray diffraction (XRD) pattern results verifying crystallinity of the hetero-junction structure material between the nano-materials of an electrocatalyst composite for water electrolysis according to an embodiment of the present invention;

FIG. 12 is a graph showing the analysis results of the Raman spectra of an electrocatalyst composite for water electrolysis according to an embodiment of the present invention;

FIG. 13 is graphs showing the X-ray photoelectron spectroscopy (XPS) spectra results confirming the elemental composition analysis and atomic bonding states of an electrocatalyst composite for water electrolysis according to an embodiment of the present invention; Here, (a) of FIG. 13 represents the XPS spectra results of S 2p for the 2D transition metal dichalcogenide material, (b) of FIG. 13 represents the XPS spectra results of Re 4f for the 2D transition metal dichalcogenide material, (c) of FIG. 13 represents the XPS spectra results of Co 2p for the 2D transition metal dichalcogenide material, and (d) of FIG. 13 represents the XPS spectra results of Ni 2p for the 2D transition metal dichalcogenide material.

FIG. 14A represents the HER polarization curve which is graphs showing the results of the electrochemical performance analysis of an electrocatalyst composite for water electrolysis in an alkaline electrolyte (1M KOH) according to an embodiment of the present invention.

FIG. 14B represents the Tafel plot which is graphs showing the results of the electrochemical performance analysis of an electrocatalyst composite for water electrolysis in an alkaline electrolyte (1M KOH) according to an embodiment of the present invention.

FIG. 14C represents the Nyquist plot which is graphs showing the results of the electrochemical performance analysis of an electrocatalyst composite for water electrolysis in an alkaline electrolyte (1M KOH) according to an embodiment of the present invention.

FIG. 14D represents the analysis of capacitive current with respect to scan rate which is graphs showing the results of the electrochemical performance analysis of an electrocatalyst composite for water electrolysis in an alkaline electrolyte (1M KOH) according to an embodiment of the present invention.

FIG. 14E represents the results of the electrochemical stability experiment which is graphs showing the results of the electrochemical performance analysis of an electrocatalyst composite for water electrolysis in an alkaline electrolyte (1M KOH) according to an embodiment of the present invention.

FIG. 14F represents the Chronopotentiometry curve graph at an uncompensated current density of 10 mA cm−2 which is graphs showing the results of the electrochemical performance analysis of an electrocatalyst composite for water electrolysis in an alkaline electrolyte (1M KOH) according to an embodiment of the present invention.

FIG. 15A represents the HER polarization curve which is graphs showing the results of the electrochemical performance analysis of an electrocatalyst composite for water electrolysis in an acidic electrolyte (0.5M H2SO4) according to an embodiment of the present invention.

FIG. 15B represents the Tafel plot which is graphs showing the results of the electrochemical performance analysis of an electrocatalyst composite for water electrolysis in an acidic electrolyte (0.5M H2SO4) according to an embodiment of the present invention.

FIG. 15C represents the Nyquist plot which is graphs showing the results of the electrochemical performance analysis of an electrocatalyst composite for water electrolysis in an acidic electrolyte (0.5M H2SO4) according to an embodiment of the present invention.

FIG. 15D represents the analysis of capacitive current with respect to scan rate which is graphs showing the results of the electrochemical performance analysis of an electrocatalyst composite for water electrolysis in an acidic electrolyte (0.5M H2SO4) according to an embodiment of the present invention.

FIG. 15E represents the results of the electrochemical stability experiment which is graphs showing the results of the electrochemical performance analysis of an electrocatalyst composite for water electrolysis in an acidic electrolyte (0.5M H2SO4) according to an embodiment of the present invention.

FIG. 15F represents the Chronopotentiometry curve graph at an uncompensated current density of 10 mA cm⁻² which is graphs showing the results of the electrochemical performance analysis of an electrocatalyst composite for water electrolysis in an acidic electrolyte (0.5M H2SO4) according to an embodiment of the present invention.

FIG. 16A represents the HER polarization curve which is graphs showing the results of the electrochemical performance analysis of an electrocatalyst composite for water electrolysis in a neutral electrolyte according to an embodiment of the present invention.

FIG. 16B represents the Tafel plot graph which is graphs showing the results of the electrochemical performance analysis of an electrocatalyst composite for water electrolysis in a neutral electrolyte according to an embodiment of the present invention.

FIG. 17 is diagrams illustrating the HER active sites and a graph representing the simulation computational analysis results of the HER Gibbs free energy according to an embodiment of the present invention; and

FIG. 18A represents an image showing the application of the electrocatalyst composite for water electrolysis to both the anode and cathode.

FIG. 18B is a graph representing the overall water splitting performance measurement of the electrocatalyst composite for water electrolysis according to an embodiment of the present invention.

FIG. 18C is a graph representing the overall water splitting performance measurement of the electrocatalyst composite for water electrolysis according to an embodiment of the present invention.

FIG. 18D is a graph representing the Gas chromatography results which is a result of the electrocatalyst composite for water electrolysis according to an embodiment of the present invention.

### DETAILED DESCRIPTION OF THE INVENTION

Hereinafter, the present invention will be described with reference to the accompanying drawings. However, the present invention may be embodied in many different forms and is not limited to the embodiments described herein. In order to clearly describe the present invention, parts irrelevant to the description may be omitted in the drawings, and similar reference numerals may be used for similar components throughout the specification.

Throughout the specification, when a part is said to be “connected (coupled, contacted, or combined)” with another part, this is not only “directly connected”, but also “indirectly connected” with another member in between. In addition, when a certain part is said to “include” certain components, this means that the part does not exclude other components but rather allows for the inclusion of additional components, unless specifically stated otherwise.

The terminology used herein is for the purpose of describing particular embodiments only and is not intended to be limiting of the invention. As used herein, the singular forms are intended to include the plural forms as well, unless the context clearly indicates otherwise. It will be further understood that the terms “comprises” or “has,” when used in this specification, specify the presence of a stated feature, number, step, operation, component, element, or a combination thereof, but they do not preclude the presence or addition of one or more other features, numbers, steps, operations, components, elements, or combinations thereof.

Hereinafter, embodiments of the present invention will be described in detail with reference to the accompanying drawings.

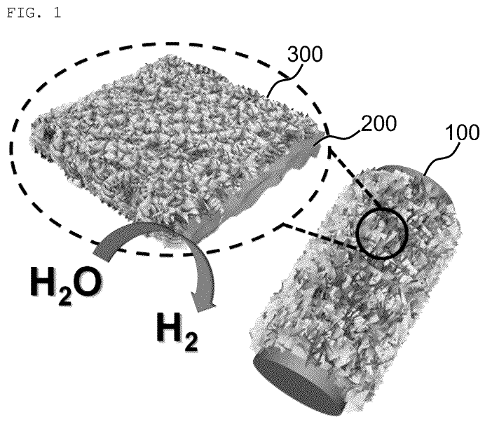

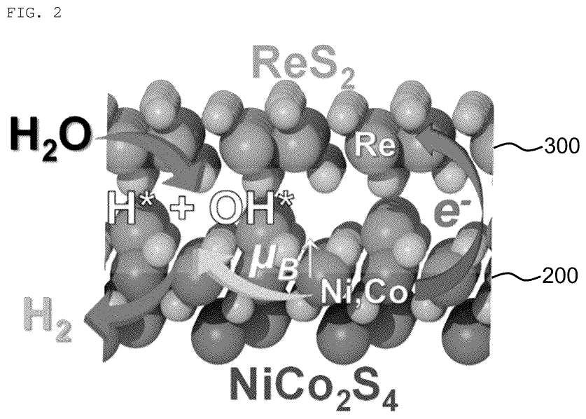

A description is made of the electrocatalyst composite for water electrolysis according to an embodiment of the present invention with reference to FIGS. 1 and 2.

FIG. 1 is a schematic diagram illustrating a structure of an electrocatalyst composite for water electrolysis according to an embodiment of the present invention;

FIG. 2 is a diagram illustrating an electron transport mechanism of an electrocatalyst composite for water electrolysis according to an embodiment of the present invention;

With reference to FIG. 1, the electrocatalyst composite for water electrolysis according to an embodiment of the present invention includes a carbon substrate 100, a first transition metal chalcogenide layer 200 composed of 2D first transition metal chalcogenide nanoparticles, positioned on the carbon substrate, and a second transition metal chalcogenide layer 300 composed of 2D second transition metal chalcogenide nanoparticles, positioned on the first transition metal chalcogenide layer, wherein the first and second transition metal chalcogenide layers may be hetero-junctioned.

The first and second transition metal chalcogenide layers 200 and 300 may hetero-junctioned to allow electron transfer from the first transition metal chalcogenide layer 200 to the second transition metal chalcogenide layer 300.

The first transition metal chalcogenide layer may be composed of a metal sulfide containing one or more metals selected from the group consisting of nickel, cobalt, calcium, magnesium, manganese, iron, copper, zinc, lithium, and aluminum, along with sulfur, and the electrocatalyst composite for water electrolysis may be used as an electrode catalyst for oxygen evolution reaction (OER) and hydrogen evolution reaction (HER).

The conventional rhenium sulfide (ReS₂) used for water electrolysis has been limited by the kinetic constraints of slow O—H bond cleavage dynamics for alkaline HER. To overcome these obstacles, the present invention can provide an electrolysis electrocatalyst composite with improved HER activity and long-term stability over a wide pH range by forming a hetero-junction structure between two or more different materials for both acidic and alkaline HER.

The present invention may include a carbon substrate 100.

The carbon substrate used in the present invention may be one or more selected from the group consisting of carbon cloth, carbon fiber paper, carbon foam, or carbon paper, or any other carbon material with electrical conductivity properties, without any particular limitations.

The present invention may also include a first transition metal chalcogenide layer 200 and a second transition metal chalcogenide layer 300 that are hetero-junctioned.

The term chalcogenide represents a material composed of binary or higher compounds containing one or more chalcogen elements, such as sulfur (S), selenium (Se), and tellurium (Te), excluding oxygen (O), from the 6^{th} group of the periodic table.

Initially, chalcogenides were known as materials referring to compounds exhibiting phase change properties, but recently, the term has been expanded to encompass materials consisting of binary or higher compounds containing sulfur, selenium, and tellurium, thereby having a more comprehensive meaning.

Meanwhile, there is a drawback in using transition metal dichalcogenides (TMDCs) universally in alkaline HER due to their slow dynamic characteristics in the initial water dissociation stage; the present invention addresses this drawback by featuring the formation of a composite structure through hetero-junction of 2D transition metal dichalcogenides (TMDCs).

Due to its thin structure, large specific surface area, and low hydrogen adsorption free energy, the 2D transition metal dichalcogenides (TMDCs) are suitable materials for use in hetero-junction/composite structures.

Therefore, the present invention may involve the hetero-junctioned existence of the first and second transition metal chalcogenide layers 200 and 300.

Hereinafter, a description is made of the first transition metal chalcogenide layer 200.

The first transition metal chalcogenide layer 200 may be composed of a metal sulfide containing one or more metals selected from a group consisting of 2D nickel, cobalt, calcium, magnesium, manganese, iron, copper, zinc, lithium, and aluminum, along with sulfur, and is located on the carbon substrate.

The reason for using nickel cobalt sulfide (NiCo₂S₄) nanoparticles as the first transition metal chalcogenide material is its excellent catalytic activity in the oxygen evolution reaction (OER) and its superior water-splitting capability.

Moreover, the nickel cobalt sulfide (NiCo₂S₄) nanoparticles can significantly enhance the activity of the hydrogen evolution reaction (HER) by adjusting the electron density and modifying the electron density through electron transfer effects, making them suitable for use as hetero-junction materials.

The nickel cobalt sulfide (NiCo₂S₄) nanoparticles may be formed on the carbon substrate in such a way as to form the first transition metal layer on the carbon substrate and then form the first transition metal chalcogenide layer by performing a sulfidation reaction on the first transition metal layer.

The first transition metal may be composed of a layered double hydroxide (NiCo-LDH) nanosheet containing nickel and cobalt metals.

The first transition metal chalcogenide layer may be formed by performing a chalcogenization reaction of sulfurization, selenization, or tellurization on the first transition metal layer.

The thickness of the first transition metal chalcogenide layer 200 may range from 20 nm to 50 nm.

The thickness of the first transition metal chalcogenide layer 200 is preferably between 20 nm and 50 nm, as a thickness less than 20 nm could compromise the stability for the application of the second transition metal chalcogenide layer 300, while a thickness exceeding 50 nm might result in reduced catalytic efficiency due to the thickened heterojunction interface as the catalytic active sites.

Hereinafter, a description is made of the second transition metal chalcogenide layer 300.

The second transition metal chalcogenide layer 300 may be positioned on the first transition metal chalcogenide layer 200 and may be composed of 2D rhenium sulfide (ReS₂).

The ReS₂ has a weaker interlayer coupling interaction compared to other Mo or W-based transition metal chalcogenide (TMDC) compounds, making it more conducive to active site exposure and interlayer electrolyte ion diffusion and thus holding great potential as a catalyst for the hydrogen evolution reaction (HER).

In the design of the ReS₂-based HER catalyst, various research efforts, including elemental doping, chemical exfoliation, and the fabrication of structural composites with conductive supports, have been commonly pursued, but the slow O—H bond cleavage dynamics of ReS₂ have hindered overcoming the reaction kinetic limitations for alkaline HER.

Therefore, in this invention, to enhance the alkaline HER catalytic performance of ReS₂, a material (first transition metal chalcogenide) possessing superior water-splitting capabilities in alkaline HER is hetero-junctioned with ReS₂ (as the second transition metal chalcogenide).

That is, the present invention is characterized by the production of an electrode catalyst that exhibits excellent catalytic activity in the oxygen evolution reaction (OER) and the hydrogen evolution reaction (HER) by hetero-junctioning a first transition metal chalcogenide material with superior catalytic activity in the OER and excellent water O-H bond cleavage capability with a transition metal chalcogenide material that facilitates active site exposure and interlayer electrolyte ion diffusion.

Here, the electrocatalyst composite for water electrolysis according to an embodiment of the present invention may be universally used for alkaline HER due to the fast dynamic characteristics of the first transition metal chalcogenide material in the initial water dissociation phase.

The principle behind the superior performance of the electrocatalyst composite for alkaline HER lies in the chemical bonding through hetero-junction between the first transition metal chalcogenide compound (NiCo₂S₄) and the second transition metal chalcogenide compound (ReS₂), which may induce electron transfer from Ni and Co to the S atoms adjacent to the Re atoms at the interface.

Thus, it can be elucidated that the junction interface of the first transition metal chalcogenide compound (NiCo₂S₄) and the second transition metal chalcogenide compound (ReS₂) facilitates hydrogen diffusion and desorption reactions more easily from a reaction kinetics perspective, which can clearly account for enhanced acidic HER activity and metal spin.

The spin crossover from low to high spin in the Ni and Co atoms at the junction interface between the first transition metal chalcogenide compound (NiCo₂S₄) and the second transition metal chalcogenide compound (ReS₂) may promote water dissociation dynamics, which may influence the enhancement of alkaline HER rates.

Therefore, the electrocatalyst composite according to an embodiment of the present invention can exhibit excellent HER activity with overpotentials of 85 and 126 mV at a reference current density of 10 mA cm−2 under alkaline and acidic conditions, along with Tafel slopes of 78.3 and 67.8 mV dec−1, respectively, indicating superior alkaline HER activity compared to most reported Re-based TMDC catalysts.

Here, the thickness of the second transition metal chalcogenide 300 layer may range from 5 nm to 30 nm.

The thickness of the second transition metal chalcogenide layer 300 is preferably between 5 nm, as thicknesses less than 5 nm may compromise stability, and thicknesses exceeding 30 nm may lead to reduced catalytic efficiency due to the heterojunction interface as the active site.

The electrocatalyst composite for the water electrolysis according to an embodiment of the present invention may exhibit catalytic activity in solutions with a pH ranging from 1 to 14.

The electrode including the electrocatalyst composite for water electrolysis may function as an overall water splitting catalyst, demonstrating high activity, selectivity, and stability for both O2 and H2 production at both the cathode and anode in alkaline electrolyte, with over 95% Faraday efficiency for 28 hours at 10 mA cm−2.

The proof of the performance of the electrocatalyst composite for water electrolysis will be detailed in the following experimental examples.

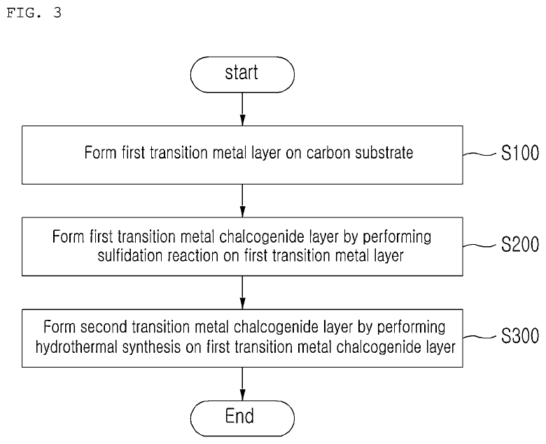

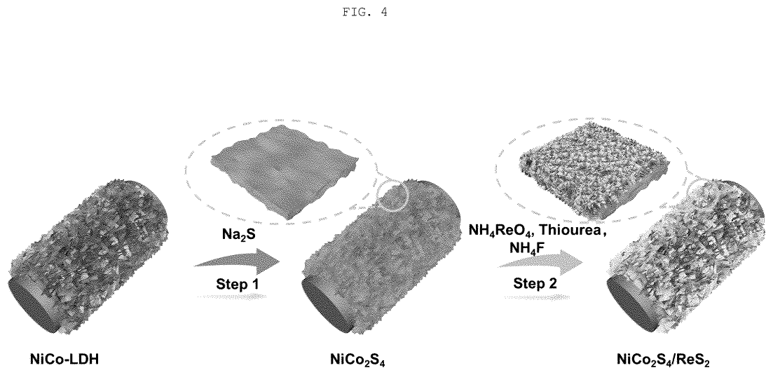

A description is made of the method of manufacturing an electrocatalyst composite for water electrolysis according to an embodiment of the present invention with reference to FIGS. 3 and 4.

FIG. 3 is a flowchart illustrating a manufacturing method of an electrocatalyst composite for water electrolysis according to an embodiment of the present invention;

FIG. 4 is a schematic diagram illustrating a manufacturing method of an electrocatalyst composite for water electrolysis according to an embodiment of the present invention;

According to another embodiment of the present invention, the method of manufacturing an electrocatalyst composite for water electrolysis may include forming a first transition metal layer on a carbon substrate at step S100, forming a first transition metal chalcogenide layer by performing a sulfidation reaction on the first transition metal layer at step S200, and forming a second transition metal chalcogenide layer by performing a hydrothermal synthesis on the first transition metal chalcogenide layer at step S300.

At step S100, the first transition metal layer is formed on the carbon substrate.

The carbon substrate may be composed of carbon cloth or any other carbon material possessing electrical conductivity characteristics.

The first transition metal may also be composed of layered double hydroxide (LDH) nanosheets.

The metal layered double hydroxide (LDH) is known to be a catalyst for the oxygen evolution reaction, featuring a two-dimensional nanostructure with weakly bonded anion layers that balance the charges between the positively charged brucite-like metal hydroxide layers.

Here, organic and inorganic anions are positioned between the positively charged sheets, resulting in a neutral charge, and the open sheet structure facilitate material transfer and ion conduction.

According to an embodiment of the present invention, the first transition metal may be composed of a layered double hydroxide (LDH) containing nickel and cobalt and may further include other layered double hydroxide (LDH) materials selected from the group consisting of calcium, magnesium, manganese, iron, copper, zinc, lithium, or aluminum.

According to an embodiment of the present invention, the carbon substrate, which is hydrophobic makes it difficult to directly form 2D transition metal chalcogenide compounds thereon, may be rendered hydrophilic through acid treatment facilitating the growth of 2D transition metal layer double hydroxides thereon.

For example, the first transition metal layer may be formed in such a way as to add cobalt nitrate hexahydrate (1 mmol), nickel nitrate hexahydrate (0.5 mmol), and metenamine (600 mg) to methanol (30 mL), immerse the treated carbon cloth piece in the solution in a 50 mL autoclave at 180° C. for 12 hours followed by natural cooling to 25° C., and carefully rinse the film with water and drying it overnight at 60° C.

At step S200, the first transition metal chalcogenide layer is formed by performing a sulfidation reaction on the first transition metal layer.

To form the first transition metal chalcogenide layer, a sulfidation reaction may be performed via hydrothermal synthesis.

For example, the first transition meta chalcogenide layer may be formed by immersing a portion of the NiCo-LDH layer in a Na₂S solution (0.1 M) at 160° C. for 8 hours followed by natural cooling to 25° C. and rinsing the successfully synthesized NiCo₂S₄ film with water and drying the film at 60° C. for 5 hours.

Here, the first transition metal chalcogenide layer may be composed of a two-dimensional form of nickel cobalt sulfide (NiCo2S4), and it can be composed of metal sulfide materials including calcium, magnesium, manganese, iron, copper, zinc, lithium, or aluminum, in addition to the nickel cobalt sulfide (NiCo2S4).

At step S300, the second transition metal chalcogenide layer may be formed by performing a hydrothermal synthesis on the first transition metal chalcogenide layer.

The second transition metal chalcogenide layer may be formed on the first transition metal chalcogenide layer via hydrothermal synthesis, specifically by immersing a NiCo₂S₄ sample in a solution of ion water (25 mL) containing ammonium thiosulfate (50 mg), sulfur element (80 mg), and NH4F (200 mg) and in anhydrous ethanol (5 mL), and then reacting the solution and sample in an autoclave at 220° C. for 6 hours, followed by cooling, washing three times with ethanol and deionized water, and drying overnight in a vacuum oven at 60° C.

The second transition metal chalcogenide layer may be composed of 2D rhenium sulfide (ReS₂) and may further include materials such as molybdenum disulfide, tungsten disulfide, molybdenum selenide, tungsten selenide, molybdenum telluride, manganese selenide, hafnium sulfide, iridium sulfide, niobium sulfide, niobium selenide, tantalum sulfide, tantalum selenide, titanium sulfide, titanium selenide, zirconium sulfide, selenium rhenium, or tellurium rhenium, in addition to the rhenium sulfide.

Here, the first and second transition metal chalcogenide layers are characterized by being hetero-junctioned, allowing for the movement of electrons from the first transition metal chalcogenide layer to the second transition metal chalcogenide layer.

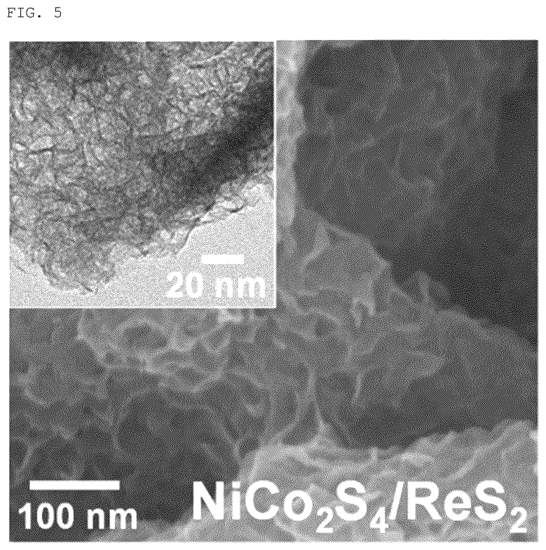

The electrocatalyst composite for water electrolysis (NiCo2S4/ReS2) produced by the above-described method shows the heterojunction of the first transition metal chalcogenide (NiCo2S4) and the second transition metal chalcogenide (ReS2), as can be observed in the SEM image representing the electrocatalyst composite in FIG. 5.

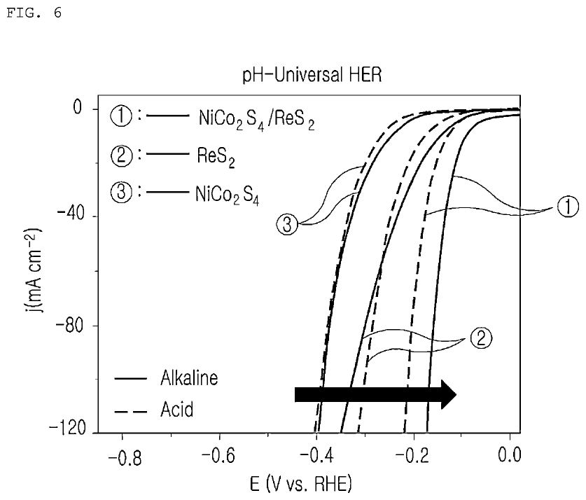

With reference to the graph depicting the HER activity of the electrocatalyst composite for water electrolysis in FIG. 6, it can be observed that the HER polarization curves exhibit improved alkaline and acidic HER activity as a simulation result of the heterojunction-induced metal spin crossover from low to high spin.

Hereinafter, a description is made of the present invention in more detail through manufacturing and experimental examples. These manufacturing and experimental examples are solely for the purpose of illustrating the present invention, and the scope of the present invention is not limited by these manufacturing and experimental examples.

Manufacturing example: Manufacturing of electrocatalyst composite for water electrolysis

### 1) NiCo-LDH Synthesis

First, a mixture was prepared by adding cobalt nitrate hexahydrate (1 mmol), nickel nitrate hexahydrate (0.5 mmol), and metenamine (600 mg) to methanol (30 mL).

Next, the treated carbon cloth piece was immersed in the above mixture (50 mL) and then placed in an autoclave, where it was allowed to react at 180° C. for 12 hours and naturally cooled to 25° C.

Finally, the film was gently rinsed with water and dried overnight at 60° C. to produce NiCo-LDH (a layered double hydroxide containing nickel and cobalt metals).

### 2) NiCo₂S₄ synthesis

First, a portion of NiCo-LDH was immersed in a Na₂S solution (0.1 M) and reacted at 160° C. for 8 hours, followed by natural cooling to 25° C., to produce NiCo₂S₄.

Next, the produced NiCo₂S₄ was washed with water and dried at 60° C. for 5 hours.

### 3) NiCo₂S₄/ReS₂ (Electrocatalyst Composite for Water Electrolysis) Synthesis

First, the prepared NiCo2S4 sample was immersed in a solution consisting of ammonium thiosulfate (50 mg), sulfur element (80 mg), and NH4F (200 mg) in deionized water (25 mL) and anhydrous ethanol (5 mL) to prepare a mixture.

Next, the mixture containing the solution and the sample was placed in an autoclave and reacted at 220° C. for 6 hours, followed by cooling, three washes with ethanol and deionized water, and overnight drying in a vacuum oven at 60° C. to generate ReS₂ on the NiCo₂S₄ layer.

In the following experimental example, NiCo₂S₄/ReS₂ refers to the electrocatalyst composite for water electrolysis according to one embodiment of the present invention.

### Experimental Example 1: Electron Microscopy Analysis of Electrocatalyst Composite for Water Electrolysis

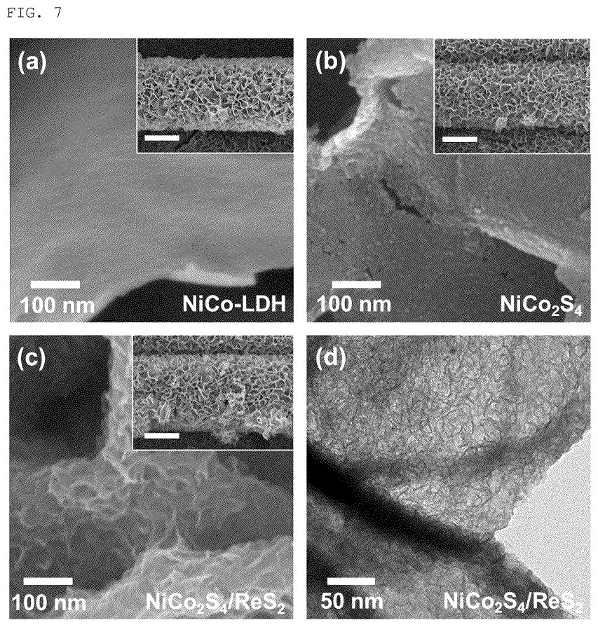

A description is made of the electrocatalyst composite for water electrolysis with reference to FIGS. 7 to 10.

FIG. 7 is SEM and TEM images observing the surface morphology of an electrocatalyst composite for water electrolysis at each step of the synthesis process according to an embodiment of the present invention.

(a) of FIG. 7 is a SEM image of NiCo-LDH, (b) of FIG. 7 is a SEM image of NiCo₂S₄, (c) of FIG. 7 is a SEM image of NiCo₂S₄/ReS₂, and (d) of FIG. 7 is a TEM image of NiCo₂S₄/ReS₂.

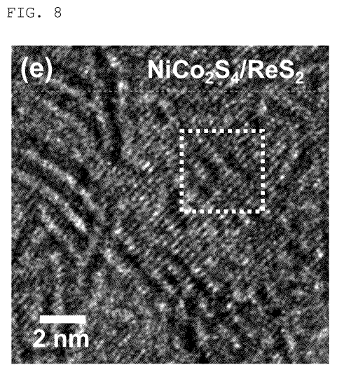

FIG. 8 is a TEM image observing the surface morphology of an electrode catalyst composite for water electrolysis according to an embodiment of the present invention.

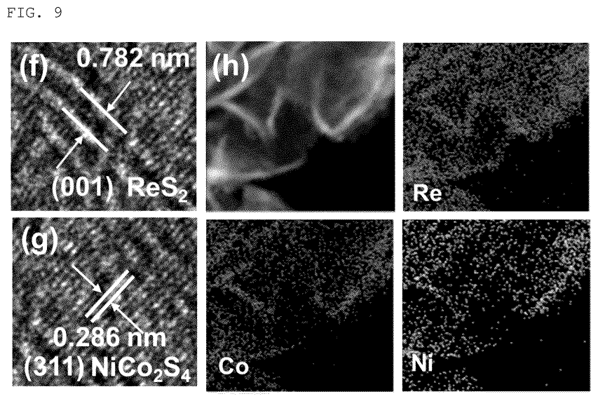

FIG. 9 is HR-TEM and EDS mapping images of an electrocatalyst composite for water electrolysis according to an embodiment of the present invention.

Here, FIG. 8 and (f) and (g) of FIG. 9 represent HR-TEM images, and (h) of FIG. 9 represents an EDS elemental mapping image.

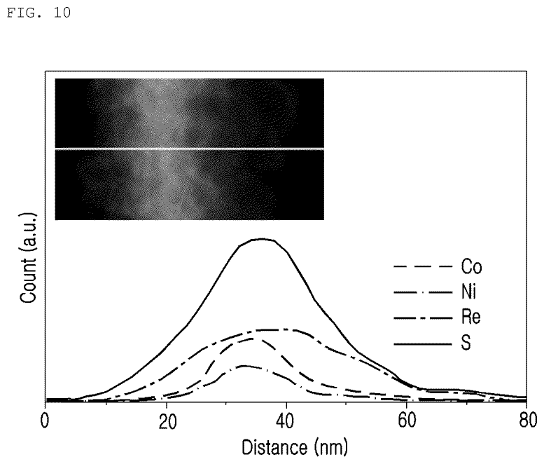

FIG. 10 is an image representing the line profile of an electrode catalyst composite for water electrolysis according to an embodiment of the present invention.

With reference to FIGS. 7 to FIG. 9, the SEM, TEM, and HR-TEM analysis results confirm that the heterojunction structure between the 2D nanomaterials is appropriately formed, as evidenced by the thickness, surface morphology, and lattice structure of the NiCo-LDH, NiCo₂S₄, and NiCo₂S₄/ReS₂ samples.

In addition, with reference to (h) of FIG. 9, the EDS elemental mapping analysis reveals the uniform distribution of Ni, Co, Re, and S on the NiCo₂S₄/ReS₂ nanosheets.

Furthermore, with reference to FIG. 10, the EDS line profile analysis confirms the broader distribution of Re compared to Ni and Co, indicating that ReS₂ is broadly decorated on the surface of NiCo₂S₄.

### Experimental Example 2: X-Ray Diffraction Pattern (XRD), Raman, X-Ray Photoelectron Spectroscopy (XPS) Analysis of Electrocatalyst Composite for Water Electrolysis

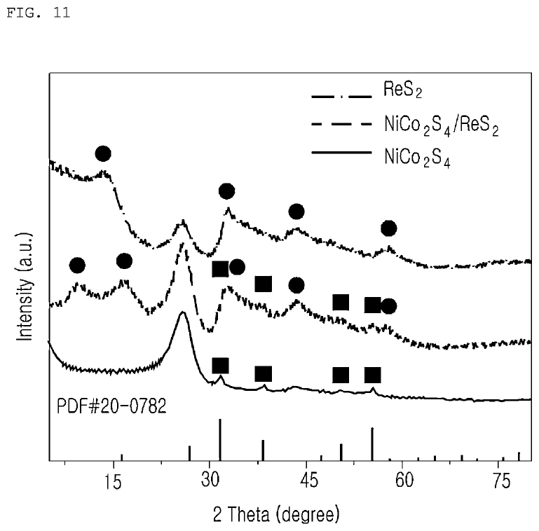

Descriptions are made of the results of the X-ray diffraction pattern (XRD), Raman, and X-ray photoelectron spectroscopy (XPS) analyses of the electrocatalyst composite for water electrolysis with reference to FIGS. 11 to 13.

FIG. 11 is a graph showing the X-ray diffraction (XRD) pattern results verifying crystallinity of the hetero-junction structure material between the nano-materials of an electrocatalyst composite for water electrolysis according to an embodiment of the present invention;

With reference to FIG. 11, when the XRD peaks of NiCo₂S₄ and ReS₂ from their Joint Committee on Powder Diffraction Standards (JCPDS) cards are compared to the peaks of NiCo₂S₄/ReS₂, it can be observed that the positions of the main peaks of the NiCo₂S₄/ReS₂ sample are revealed at the same positions as the peaks of NiCo₂S₄and ReS₂.

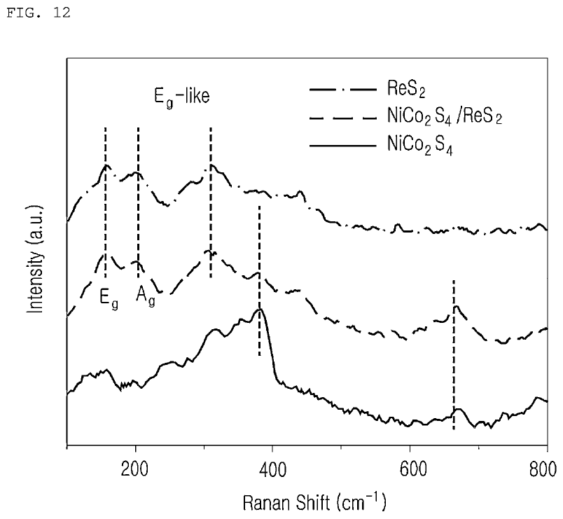

FIG. 12 is a graph showing the analysis results of the Raman spectra of an electrode catalyst composite for water electrolysis according to an embodiment of the present invention.

With reference to FIG. 12, the characteristic peaks of NiCo₂S₄and ReS₂ nanosheets are maintained even after the formation of the NiCo₂S₄/ReS₂ nanocomposite, confirming that the phase and crystal structures of NiCo₂S₄and ReS₂ are retained even after hybridization.

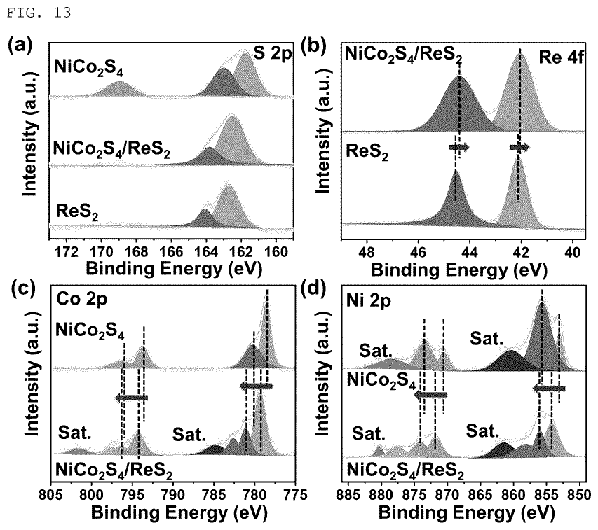

FIG. 13 is graphs showing the X-ray photoelectron spectroscopy (XPS) spectra results confirming the elemental composition analysis and atomic bonding states of an electrode catalyst composite for water electrolysis according to an embodiment of the present invention.

(a) of FIG. 13 represents the XPS spectra results of S 2p for the 2D transition metal dichalcogenide material, (b) of FIG. 13 represents the XPS spectra results of Re 4f for the 2D transition metal dichalcogenide material, (c) of FIG. 13 represents the XPS spectra results of Co 2p for the 2D transition metal dichalcogenide material, and (d) of FIG. 13 represents the XPS spectra results of Ni 2p for the 2D transition metal dichalcogenide material.

With reference to FIG. 13, in the XPS spectra of S 2p, the two peaks located at 161.7 and 163.0 eV correspond to the 2p_{3/2}and 2p_{1/2} orbitals of S2-ion bonding with Ni and Co metals in pure NiCo₂S₄, while the broad peak around 169 eV corresponds to S ions derived from SO₄⁻², indicating the penetration of sulfate ions on the surface of NiCo2S4.

In this case, when NiCo₂S₄is mixed with ReS₂, the slightly deviating peaks related to the metallic bonding of S indicate a strong chemical interaction between NiCo₂S₄ and ReS₂.

Additionally, in the case of the Re 4f region, a pair of 4f_{7/2}and 4f_{5/2} peaks were observed at 42.1 and 44.5 eV, respectively, for pure ReS₂, while in the case of NiCo2S4/ReS2, the peaks shifted to the lower energy region.

In the case of the Co 2p peak of pure NiCo₂S₄, the 2p_{1/2} peak is located at 778.6 (Co³⁺) and 780.2 eV (Co²⁺), while the corresponding 2p_{3/2} peak is located at 783.7 and 796.3 eV, respectively.

Here, the formation of NiCo₂S₄/ReS₂ resulted in the shift of the Co 2p peak to a higher energy region, which is accompanied by the evolution of a new chemical state in the XPS spectrum, suggesting a chemical bonding between the NiCo₂S₄and ReS₂ layers.

Furthermore, the strong Co 2p satellite peak for NiCo₂S₄/ReS₂ can indicate the abundance of Co³⁺ ions with high spin, whereas the satellite peak of pure NiCo₂S₄ suggests the dominance of Co ³⁺ ions with low spin.

### Experimental Example 3: Electrochemical Performance Analysis of Electrocatalyst Composite for Water Electrolysis

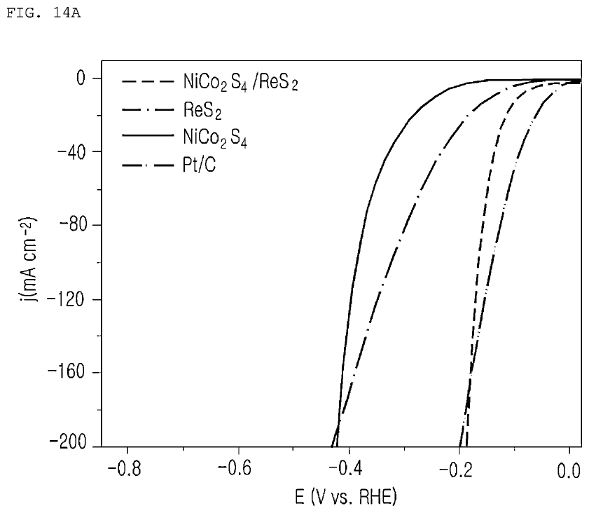

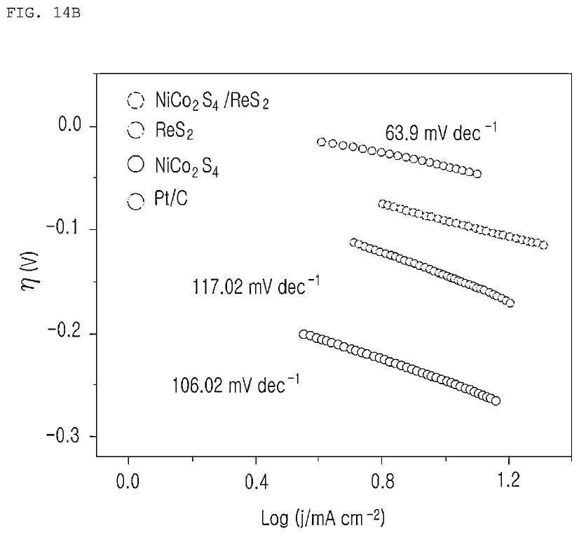

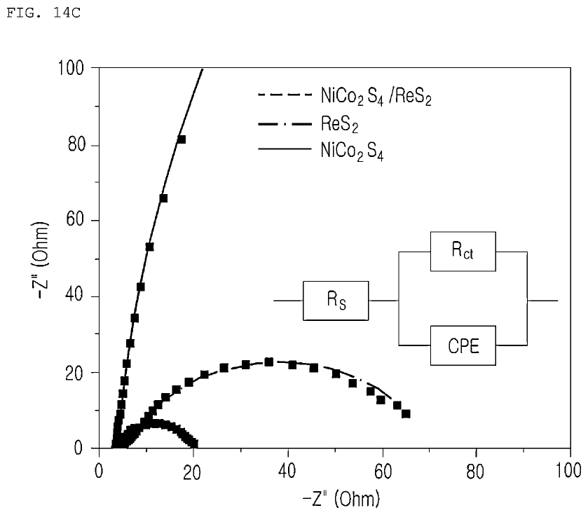

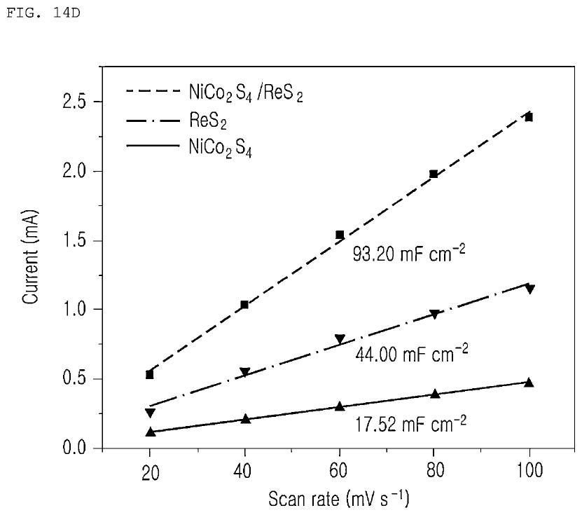

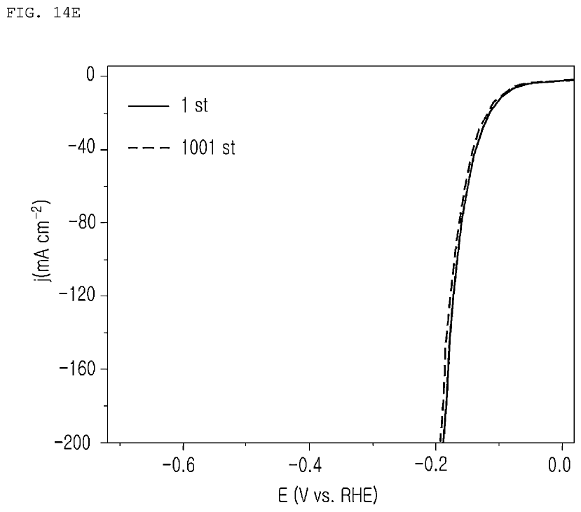

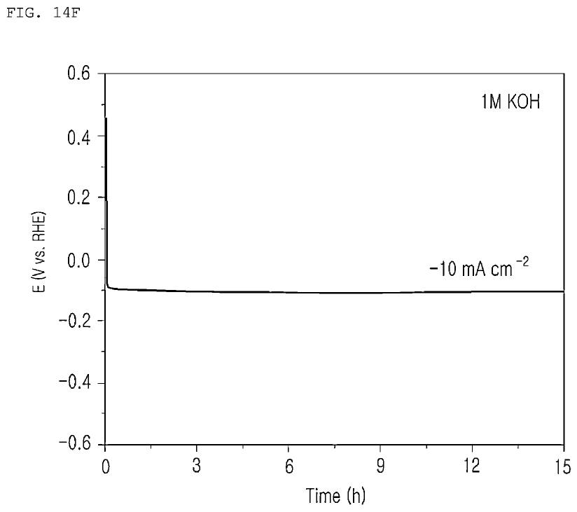

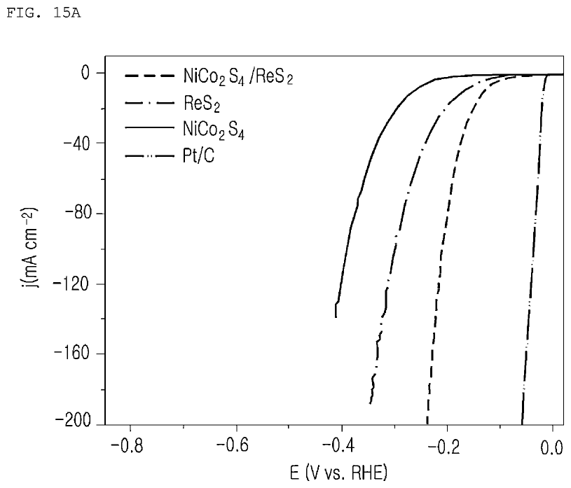

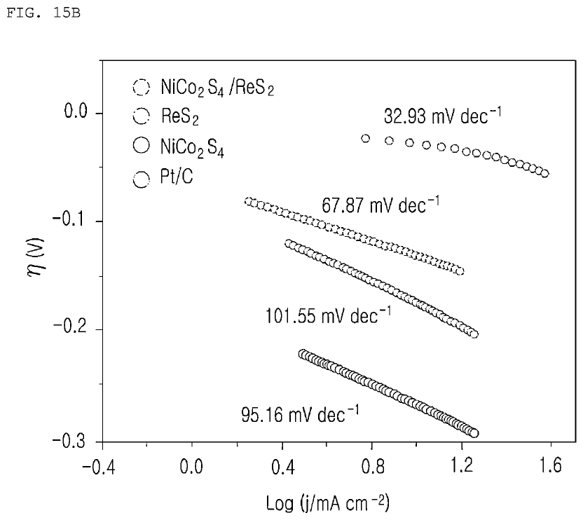

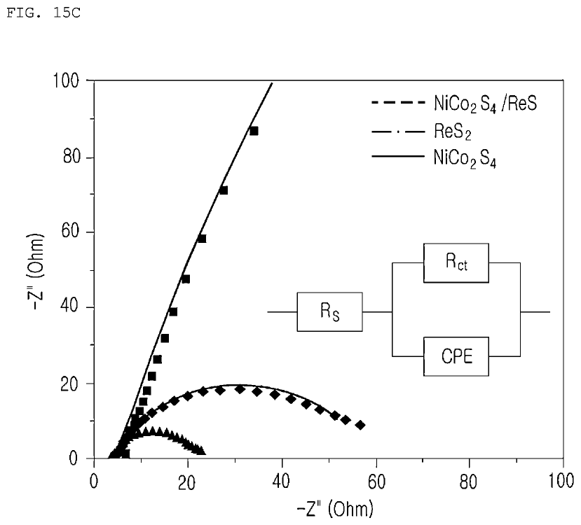

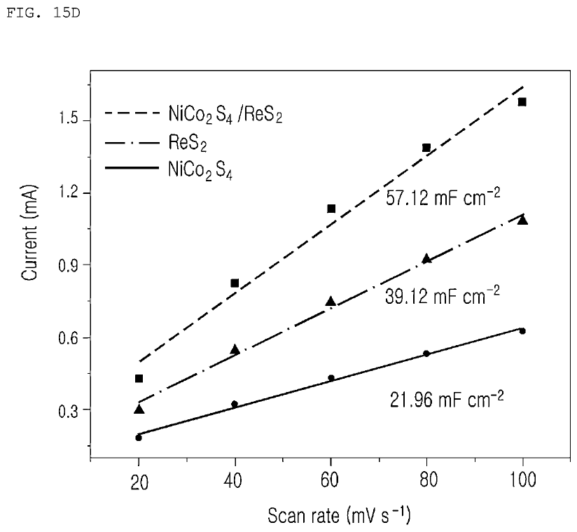

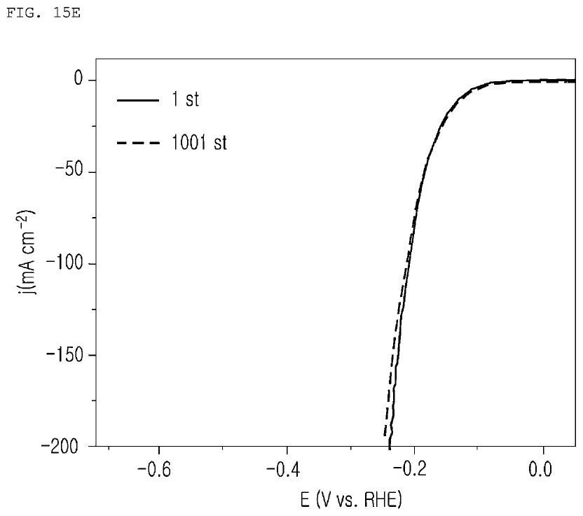

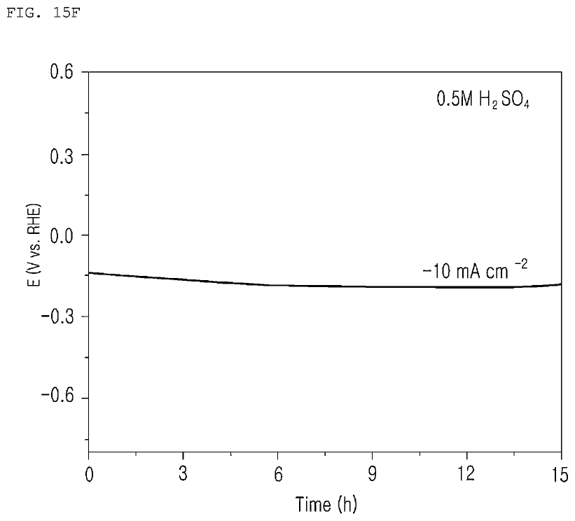

A description is made of the electrochemical performance of the electrocatalyst composite for water electrolysis with reference to FIGS. 14 and 15.

FIG. 14 is graphs showing the results of the electrochemical performance analysis of an electrocatalyst composite for water electrolysis in an alkaline electrolyte (1M KOH) according to an embodiment of the present invention;

Specifically, FIG. 14 shows the results of the electrochemical performance analysis of the hetero-junctioned material of 2D transition metal chalcogenide nanomaterials in an alkaline electrolyte (1M KOH), with the graphs of (FIG. 14a) HER polarization curves, (FIG. 14b) Tafel plots, (FIG. 14c) Nyquist plots, (FIG. 14d) analysis of capacitive current with respect to scan rate, (FIG. 14e) results of electrochemical stability experiments, and (FIG. 14f) chronopotentiometry curve at an uncompensated current density of 10 mA cm⁻².

FIG. 15 is graphs showing the results of the electrochemical performance analysis of an electrocatalyst composite for water electrolysis in an acidic electrolyte (0.5M H₂SO₄) according to an embodiment of the present invention.

FIG. 15 shows the results of the electrochemical performance analysis of the hetero-junctioned material of 2D transition metal chalcogenide nanomaterials in an acidic electrolyte (0.5M H₂ SO4), with the graphs of (FIG. 15a) HER polarization curves, (FIG. 15b) Tafel plots, (FIG. 15c) Nyquist plots, (FIG. 15d) analysis of capacitive current with respect to scan rate, (FIG. 15e) results of electrochemical stability experiments, and (FIG. 15f) chronopotentiometry curve at an uncompensated current density of 10 mA cm⁻².

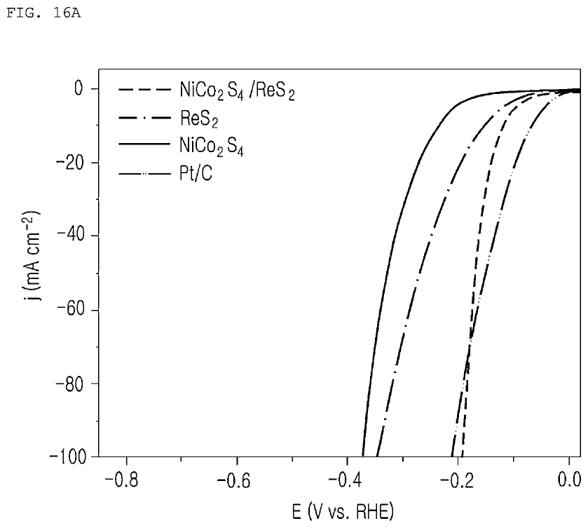

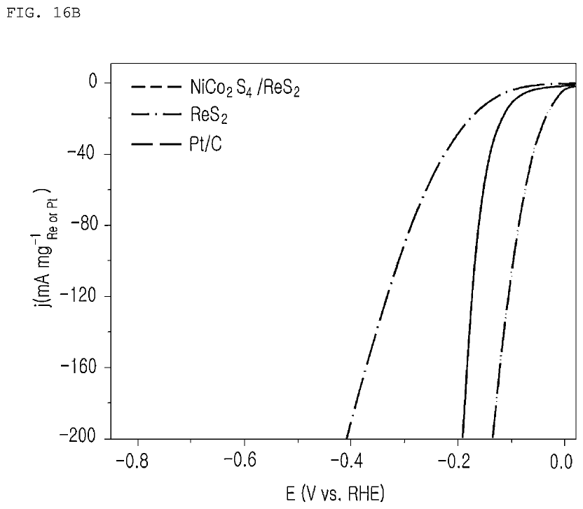

FIG. 16 is graphs showing the results of the electrochemical performance analysis of an electrocatalyst composite for water electrolysis in a neutral electrolyte (1M phosphate buffer solution (PBS)) according to an embodiment of the present invention.

FIG. 16 shows the results of the electrochemical performance analysis of the hetero-junctioned material of 2D transition metal chalcogenide nanomaterials in a neutral electrolyte (1M PBS), with the graphs of (FIG. 16a) HER polarization curves and (FIG. 16b) Tafel plot curves.

With reference to FIGS. 14 to 16, the NiCo₂S₄/ReS₂ sample exhibited the highest HER performance at a low overpotential region (85 mV) among the Re-based materials, and it also showed the dominance of the Volmer-Heyrovsky pathway in the Tafel slope, demonstrating the smallest value compared to other samples. Additionally, it can be confirmed that it demonstrated stable operation without significant performance degradation even after 15 hours of long-term durability testing.

### Experimental Example 4: Computational Analysis of Electrocatalyst Composite for Water Electrolysis

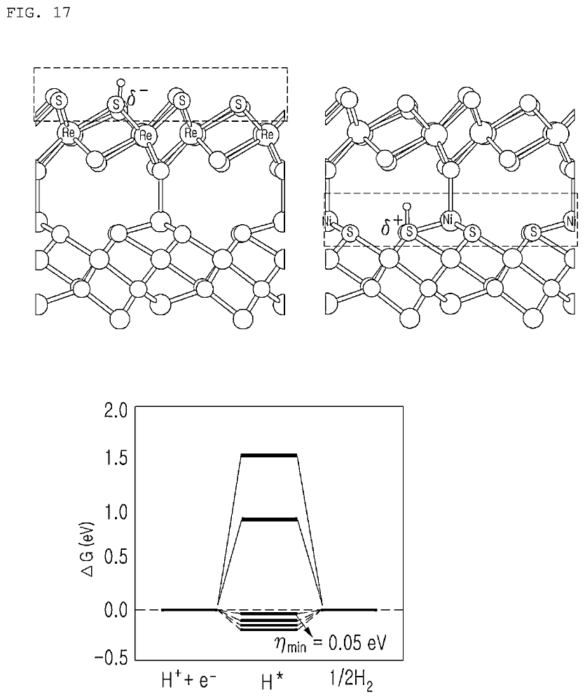

FIG. 17 is diagrams illustrating the HER active sites and a graph representing the simulation computational analysis results of the HER Gibbs free energy according to an embodiment of the present invention.

With reference to FIG. 17, it can be observed that, among various possible active sites for HER, the HER is activated at the S atomic sites at the interface (with 0.90 and 1.53 eV) rather than the S atomic sites on the external ReS₂ surface (with overpotentials ranging from 0.21 to 0.05 eV) in the HER Gibbs free energy diagram.

In this case, at the NiCo₂S₄/ReS₂ interface, Ni (or Co) atoms form Ni—S (or Co—S) bonds with the S atoms of the ReS2 layer, allowing some of the electrons to transfer from the Ni (or Co) atoms to the S atoms of the ReS₂ layer.

This leads to electron deficiency in the S atoms proximal to Ni or Co, which is consistent with the observed XPS results.

Furthermore, to verify the spin crossover effect that can promote the dissociation of molecular adsorbates by inducing spin crossover from low-spin to high-spin surface metal sites, the spin states of the metal sites on the surface of pure NiCo₂S₄ were investigated through DFT simulations of the NiCo₂S₄/ReS₂ interface.

As a result, it can be observed that any method enabling spin crossover from low-spin to high-spin on the surface and/or interface metal sites through electron transfer or modulation of electron density can enhance the water dissociation kinetics, which may be utilized to promote alkaline HER or OER.

### Experimental Example 5: Measurement of Overall Water Splitting Performance and Gas Chromatography Analysis of Electrocatalyst Composite for Water Electrolysis

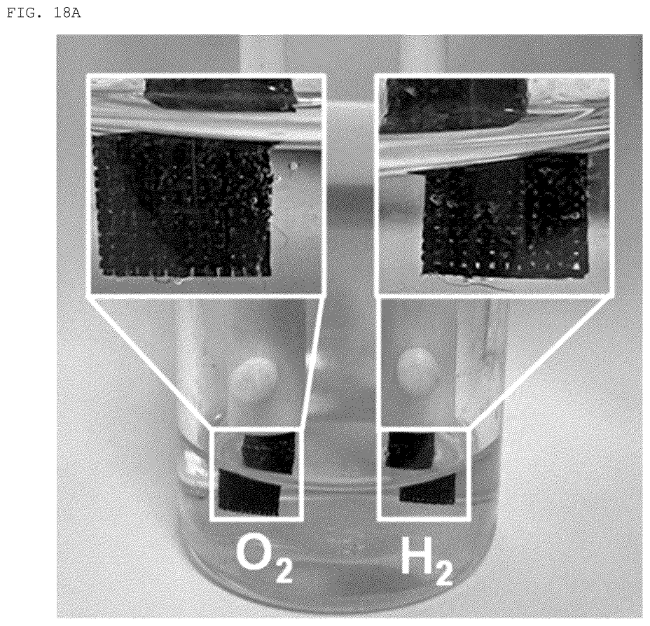

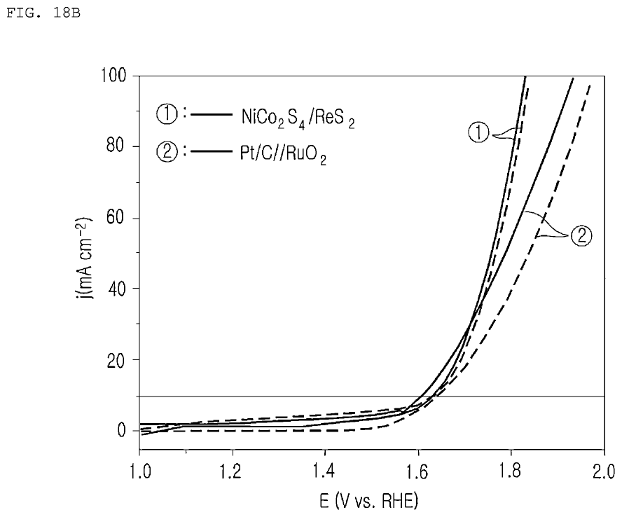

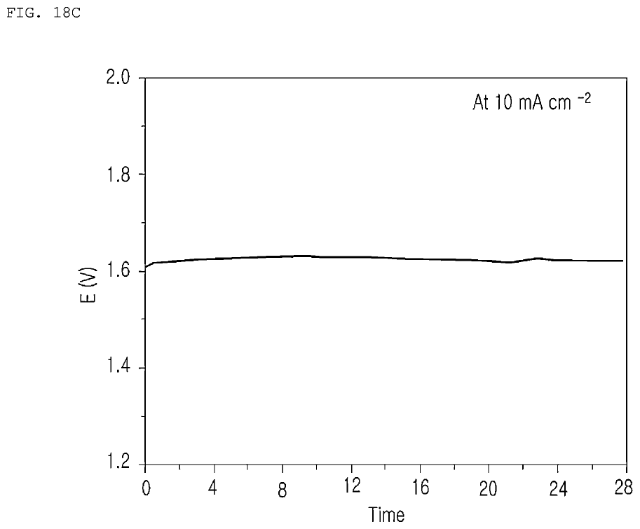

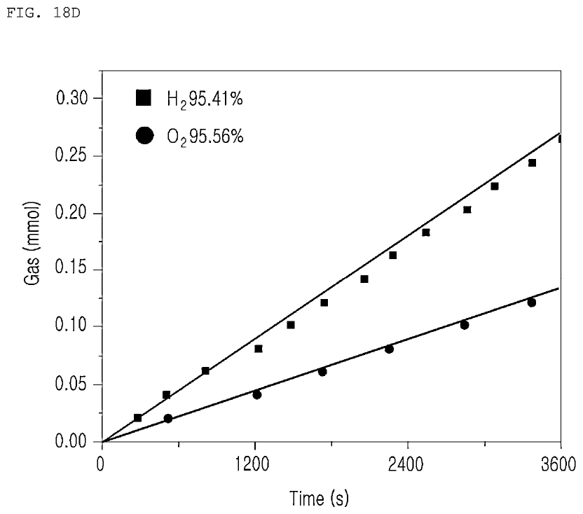

FIG. 18 is an image and graphs showing the overall water splitting performance measurement and gas chromatography results of the electrocatalyst composite for water electrolysis according to an embodiment of the present invention. Here, FIG. 18a an image showing the application of the electrocatalyst composite for water electrolysis to both the anode and cathode, (FIG. 18b) and (FIG. 18c) are graphs representing the overall water splitting performance measurement, and (FIG. 18d) is a graph representing the Gas chromatography results.

With reference to FIG. 18a, it can be observed that the electrocatalyst composite for water electrolysis produces oxygen gas and hydrogen gas when applied to the anode and cathode, respectively.

With reference to FIG. 18, it can also be observed that the performance and stability are excellent even in overall water splitting. Furthermore, the Gas Chromatography measurements revealed that both the anode and cathode exhibited over 95%

Faraday efficiency, indicating excellent performance even compared to metal-based catalysts without noble metals (as shown in FIG. 18b).

The electrocatalyst composite for water electrolysis according to an embodiment of the present invention is manufactured by hetero-junctioning 2D nickel cobalt sulfide (NiCo₂S₄) and 2D rhenium sulfide (ReS₂) to allow for high activity and application over a broad pH range during water electrolysis.

It should be understood that the advantages of the present invention are not limited to the aforesaid but include all advantages that can be inferred from the detailed description of the present invention or the configuration specified in the claims.

The above description of the present invention is for illustrative purposes only, and it will be understood by those skilled in the art that various modifications and changes may be made thereto without departing from the spirit and scope of the invention. Therefore, it should be understood that the embodiments described above are exemplary and not limited in all respects. For example, each component described as a single type may be implemented in a distributed manner, and similarly, components described as distributed may be implemented in a combined form.

The scope of the invention should be determined by the appended claims, and all changes or modifications derived from the meaning and scope of the claims and equivalent concepts thereof should be construed as being included in the scope of the present invention.

What is claimed is:

1. An electrocatalyst composite for water electrolysis, the composite comprising:
a carbon substrate;
a first transition metal chalcogenide layer comprising 2-dimensional first transition metal chalcogenide nanoparticles, positioned on the carbon substrate; and
a second transition metal chalcogenide layer comprising 2-dimensional second transition metal chalcogenide nanoparticles, positioned on the first transition metal chalcogenide layer,
wherein the first and second transition metal chalcogenide layers are hetero-junctioned.

2. The composite of claim 1, wherein the first and second transition metal chalcogenide layers are hetero-junctioned to allow electron transfer from the first transition metal chalcogenide layer to the second transition metal chalcogenide layer.

3. The composite of claim 1, wherein the first transition metal chalcogenide layer comprises a metal sulfide comprising one or more metals selected from the group consisting of nickel, cobalt, calcium, magnesium, manganese, iron, copper, zinc, lithium, and aluminum, and sulfur.

4. The composite of claim 1, wherein the second transition metal chalcogenide layer comprises molybdenum sulfide, tungsten sulfide, molybdenum selenide, tungsten selenide, molybdenum telluride, manganese selenide, hafnium sulfide, iridium sulfide, niobium sulfide, niobium selenide, tantalum sulfide, tantalum selenide, titanium sulfide, titanium selenide, zirconium sulfide, rhenium selenide, or rhenium telluride.

5. The composite of claim 1, being used as electrode catalyst for oxygen evolution reaction (OER) and hydrogen evolution reaction (HER).

6. The composite of claim 1, exhibiting catalytic activity in a solution with a pH range of 1 to 14.

7. The composite of claim 1, wherein the carbon substrate comprises one or more selected from the group consisting of carbon cloth, carbon fiber paper, carbon foam, and carbon paper.

8. The composite of claim 1, wherein the first transition metal chalcogenide layer has a thickness of 20 nm to 50 nm.

9. The composite of claim 1, wherein the second transition metal chalcogenide layer has a thickness of 5 nm to 30 nm.

10. A method of manufacturing the electrocatalyst composite for water electrolysis of claim 1, the method comprising:
forming a first transition metal layer on a carbon substrate;
forming a first transition metal chalcogenide layer by performing a sulfidation reaction on the first transition metal layer; and
forming a second transition metal chalcogenide layer by performing hydrothermal synthesis on the first transition metal chalcogenide layer.

11. The method of claim 10, wherein the first transition metal layer comprises a layered double hydroxide (LDH) nanosheet comprising one or more selected from the group consisting of nickel, cobalt, calcium, magnesium, manganese, iron, copper, zinc, lithium, and aluminum.

12. The method of claim 10, wherein the first transition metal chalcogenide layer comprises a metal sulfide comprising one or more metals selected from the group consisting of nickel, cobalt, calcium, magnesium, manganese, iron, copper, zinc, lithium, and aluminum, and sulfur.

13. The method of claim 10, wherein the second transition metal chalcogenide layer comprises one or more selected form the group consisting of 2-dimensional rhenium disulfide, molybdenum sulfide, tungsten sulfide, molybdenum selenide, tungsten selenide, molybdenum telluride, manganese selenide, hafnium sulfide, iridium sulfide, niobium sulfide, niobium selenide, tantalum sulfide, tantalum selenide, titanium sulfide, titanium selenide, zirconium sulfide, rhenium selenide, and rhenium telluride.
